(19) United States
(12) Patent Application Publication
(10) Pub. No.: US 2012/0311910 A1
(43) Pub. Date: Dec. 13, 2012

(54) RAIL MOUNT AND HANDGRIP MODIFICATION SYSTEM

(76) Inventors: Sergei Y. Mironichev, Moscow (RU); Pavel Alpatov, (US)

(21) Appl. No.: 13/335,986

(22) Filed: Dec. 23, 2011

Related U.S. Application Data
(60) Provisional application No. 61/426,835, filed on Dec. 23, 2010.

(51) Int. Cl. F41C 27/00; F41C 23/22; B23P 23/00; F41C 23/10

(52) U.S. Cl. 42/90; 42/71.02; 29/401.1

(57) ABSTRACT

A rail mount and handgrip modification system for attaching a rail mount in a non-traditional location. The rail mount modification system has a base bracket sized to fit over the barrel of a Kalashnikov-family rifle. The rail mount modification system has an upper rail portion having a top rail and an upper lateral rail coupled with a lower rail portion having a lower lateral rail. A modified pistol handgrip with an embedded remote control for wireless control of an electronic device.

### FIELD OF THE INVENTION

The present invention pertains generally to firearms. More particularly, the present invention pertains to rail systems for mounting accessories on firearms and modification systems to add rail systems to existing firearms. Additionally, the present invention pertains to modifications to a pistol grip on a firearm.

### BACKGROUND OF THE INVENTION

Many firearm users attach additional equipment such as optical sights, flashlights or laser sights to their weapons. Such equipment is attached to a rail system on the firearm. Not all firearms come with a rail system for attachments, so rail system modification systems allow a user to add a rail system to their firearm. Examples of rail systems used on firearms are known as a Picatinny rail or Weaver rail MIL-STD.

Rail system modifications are known in the art to replace parts on a firearm to accommodate for the rails. Existing rail system modification systems such as “Firearm Modification Assembly,” U.S. Pat. No. 7,231,861 B1 to Gauny address modification of a Colt M4A1 or M16. “Rail Connector and Method,” U.S. Pat. No. 6,854,206 B2 to Oz provides a rail connector mounted onto the front sight of a rifle. Other known rail mount modification systems specifically for a Kalashnikov-family rifle require modifications of existing components such as the upper or lower handguards. Furthermore, known rail mount systems cannot be positioned on the barrel of the rifle just under the gas piston tube due to structural infeasibility.

Other rail modifications known in the art are listed below:

U.S. Pat. No. 7,571,562 B2, titled “Accessory Rail for a Rifle” to Sutherby.

U.S. Pat. No. 7,191,557 B2, titled “Firearms, Grips for firearms, and Methods for Using the Same” to Gablowski, et al.

In light of the above, it is an object of the present disclosure to provide a rail system modification for a rifle based on the standardized Picatinny and Weaver rail systems. Another object of the present disclosure is a rail system modification for a rifle that adapts to the mechanical structure of the gas piston tube featured on a Kalashnikov rifle. A further object of the present disclosure is to provide a rail system modification that can be added without modifying existing parts already on a rifle. Yet another object of the present disclosure is a modified pistol grip with an embedded remote control for associated electronics.

### BRIEF SUMMARY OF THE INVENTION

In one aspect of the invention, a rail mount modification system is provided having a rail mount and a base bracket. The rail mount has an upper rail portion and a lower rail portion and is configured to receive a firearm attachment, such as a flashlight. The base bracket is attached over a barrel of a rifle rather than over a handgrip. The rail mount attaches to the base bracket to be secured to the rifle. The base bracket has a first bracket portion and a second bracket portion combined to form an inner cavity to fit the barrel of the rifle. Each bracket portion has an inner cavity approximately the size of half of the barrel.

In another aspect of the present invention, a handgrip modification system has a modified pistol grip. The modified pistol grip has an embedded remote control and a power supply to provide power to said modified pistol grip. The power supply is optimally a lithium-ion battery to achieve an extended battery life. The embedded remote control is configured to control an electronic device, such as the flashlight attached to the rail mount.

Another aspect of the present invention is directed to a method for providing a rail mount and handgrip modification. The method has the steps of providing a rail mount having an upper rail portion and a lower rail portion, a base bracket having a first bracket portion and a second bracket portion, and a modified pistol grip having an embedded remote control and a power supply to provide power to said modified pistol grip.

The invention can be better visualized by turning now to the following drawings.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a first preferred embodiment of a rail mount modification system coupled to a rifle;

FIG. 2A is a side perspective view of an upper rail portion;

FIG. 2B is an underside perspective view of the upper rail portion;

FIG. 3A is a side perspective view of a lower rail portion;

FIG. 3B is a front cross-section view of the lower rail portion;

FIG. 4A is a side perspective view of a base bracket;

FIG. 4B is a cross-section view of the base bracket;

FIG. 5A is a cross-section view of the rail mount modification system installed over a gas piston tube and a barrel of the rifle;

FIG. 5B is a side view of the installed rail mount modification system;

FIG. 5C is a left side perspective view of the base bracket;

FIG. 5D is a right side exploded view of the rail mount modification system;

FIG. 5E is a left side exploded view of the rail mount modification system;

FIG. 6A is a perspective view of a flashlight mounted on the rail mount modification system; and

FIG. 6B is a side view of a modified pistol grip with an embedded remote control for the flashlight.

### DETAILED DESCRIPTION OF THE PREFERRED EMBODIMENTS

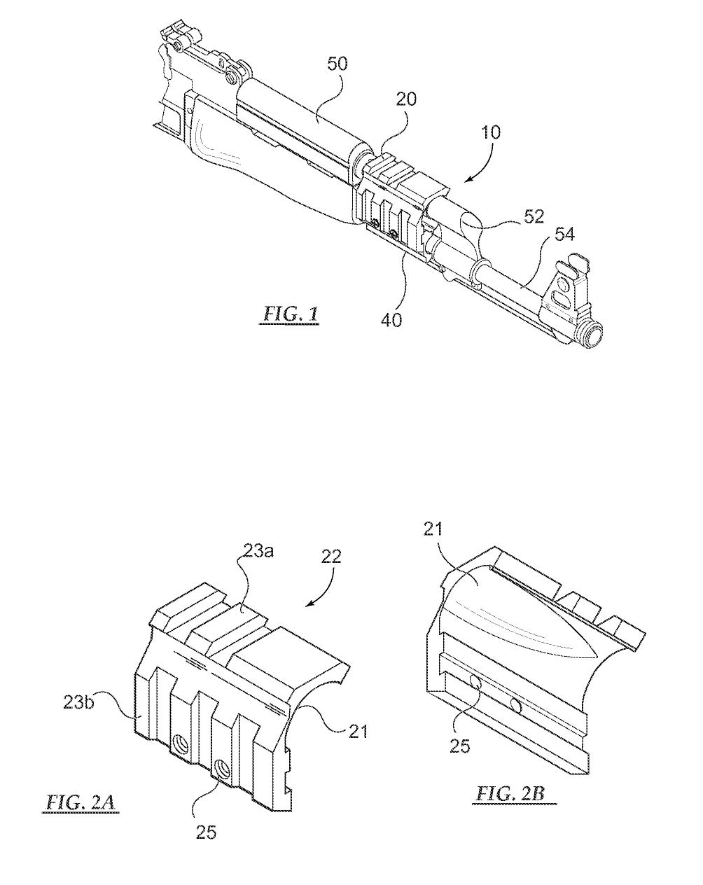

With reference to FIG. 1, a perspective view of a first preferred embodiment of a rail mount modification system 10 coupled to a rifle 50 is illustrated. The rail mount modification system 10 comprises a rail mount 20 and a base bracket 40 optimally placed in a position where they do not require a modification of existing parts such as the handguards.

The rail mount modification system 10 is arranged in a way to accommodate a gas piston tube 52 and a barrel 54 on a Kalashnikov-family rifle 50 such as the AKM or AK-47. The rail mount modification system 10 can be attached to the rifle 50 without having to do additional modifications to existing parts by fitting over the gas piston tube 52 and the barrel 54. Moreover, the position of the rail mount modification system 10 would not interfere with any existing modifications or attachments due to its unique positioning relative to the traditional positions for attachments such as the upper handguard or the lower handguard. Such unique positioning would allow for more auxiliary attachments such as a flashlight, laser sights, infrared scopes or collimator sights without interfering with other attachments such as a bayonet or grenade launcher.

Furthermore, the material used in the construction of the rail mount modification system 10 mirrors the materials used in the construction of the gas piston tube 52 and the barrel 54, so there is an identical thermal expansion factor to the barrel 54 to act a heat sink. The durability of the rail mount modification system 10 would be improved over using traditional materials.

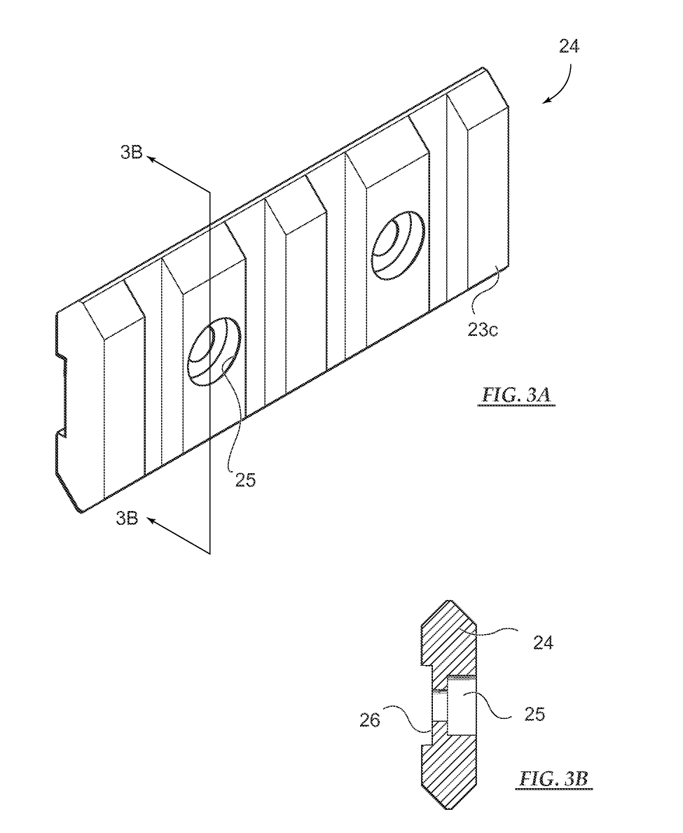

FIG. 2A depicts the upper rail portion 22 in a side perspective view. The upper rail portion 22 comprises a top rail 23a and an upper lateral rail 23b. The top rail 23a and upper lateral rail 23b can be, but not limited to, Picatinny-type or Weaver-type rails depending on the desired attachments to be used. The upper lateral rail 23c has a plurality of screw holes 25 to allow a screw to pass through an outer portion and couple with the base bracket 40 through the inner portion for stability and rigidity. FIG. 2B depicts the upper rail portion 22 from an underside perspective view. The upper rail portion 22 has an inside portion 21 curved to correspond to the gas piston tube 52. The curved nature of the inside portion 21 allows the upper rail portion 22 to fit closely to the gas piston tube 52 while maintaining proper airflow therein.

FIG. 3A illustrates the lower rail portion 24 in a side perspective view. The lower lateral rail 23c can be, but not limited to, Picatinny-type or Weaver-type rails depending on the desired attachments to be used. The lower rail portion comprises a lower lateral rail 23c. The lower rail portion has a plurality of screw holes 25 to allow a screw to pass through an outer portion and couple with the base bracket 40 through the inner portion for stability and rigidity. The lower rail portion 24 is configured to be a Picatinny rail or a Weaver rail. The lower rail portion 24's size is limited to that of the specification of a rail as to be efficient in its placement and functionality. FIG. 3B is a side cross-section view of the lower rail portion 24. The lower rail portion 24 also has a cutout 26 on its inner portion to provide a clearing for other screws protruding out of the base bracket 40.

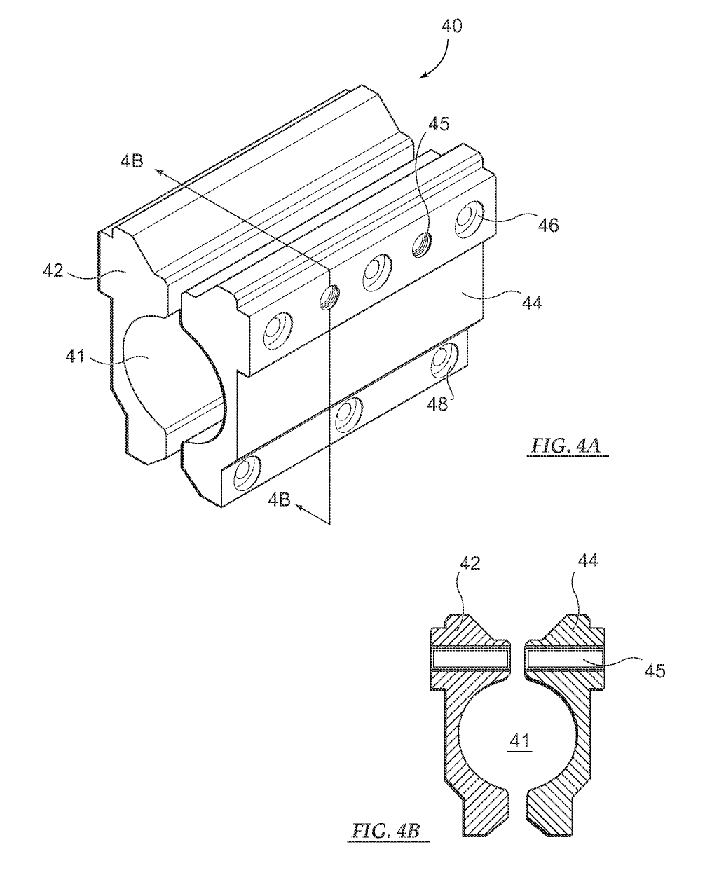

With regard to FIGS. 4A and 4B, the base bracket 40 for the rail mount modification system 10 is illustrated. The base bracket 40 comprises of a first bracket portion 42 and a second bracket portion 44. The first bracket portion 42 and the second bracket portion 44 have a plurality of upper holes 46 and lower holes 48 for receiving screws on both sides of the base bracket. The screws pass through one side of the second bracket portion 44 to attach to the first bracket portion 42 to form an inner bracket cavity 41 over the barrel 54 of the rifle 50. The bracket portions 42 and 44 can be rotated around for customized positioning of the corresponding rail portions 22 and 24. The base bracket 40 is also constructed from a material similar to that used in the construction of the barrel 52 of the Kalashnikov-family rifle 50 to provide additional durability in use.

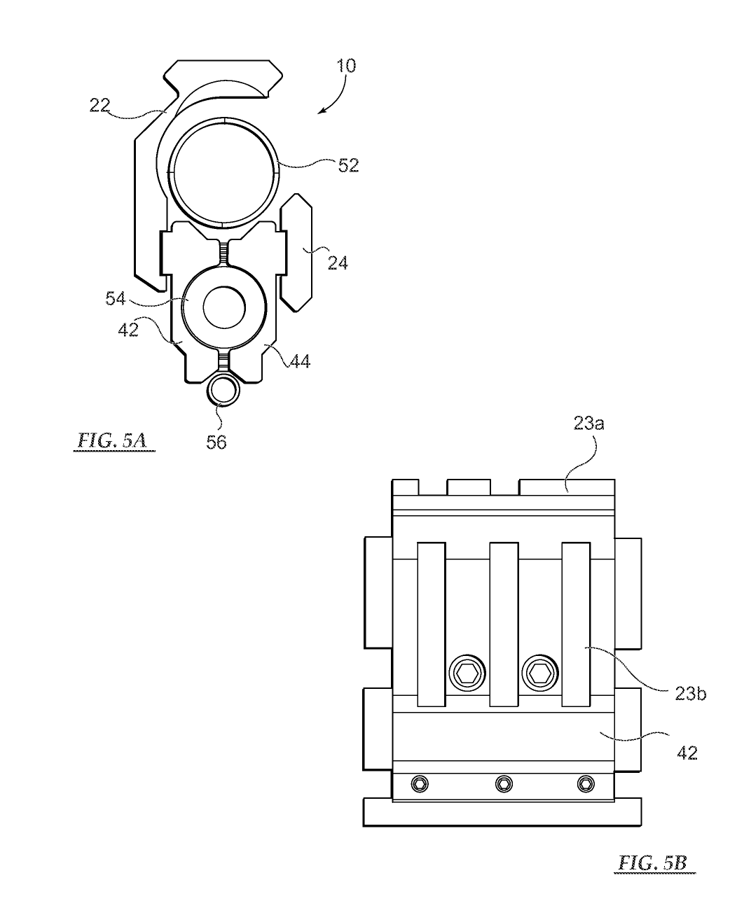

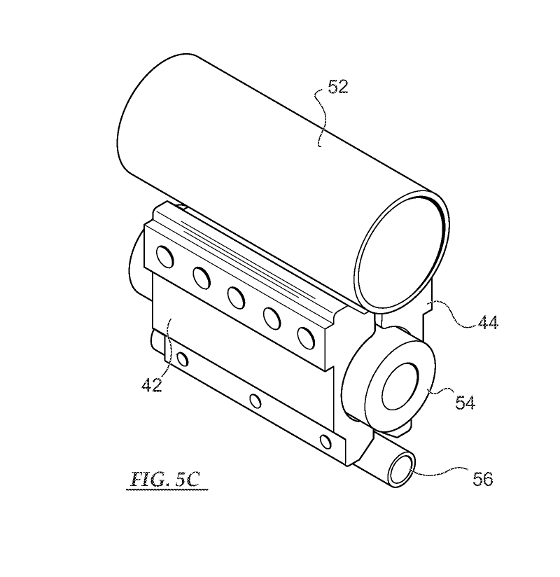

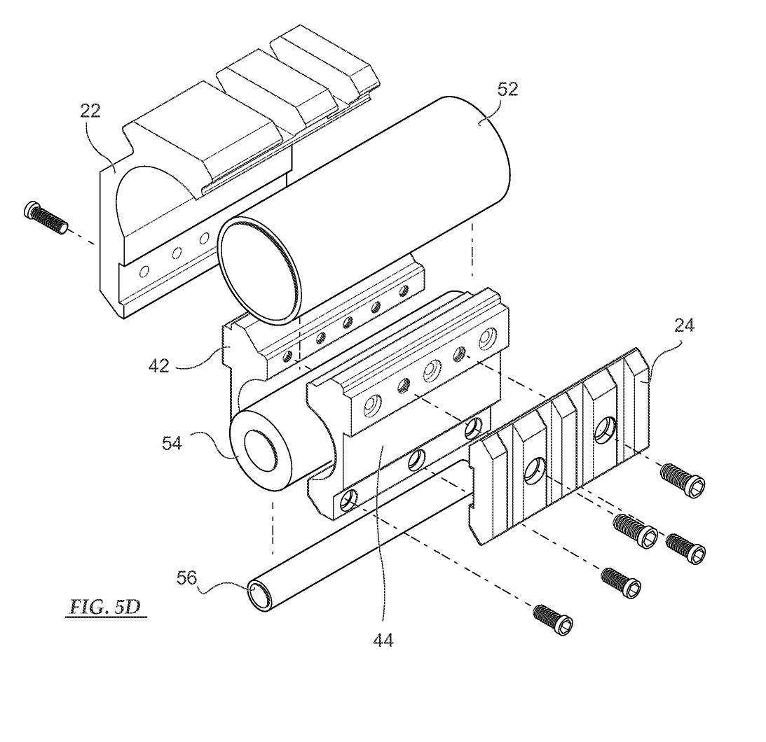

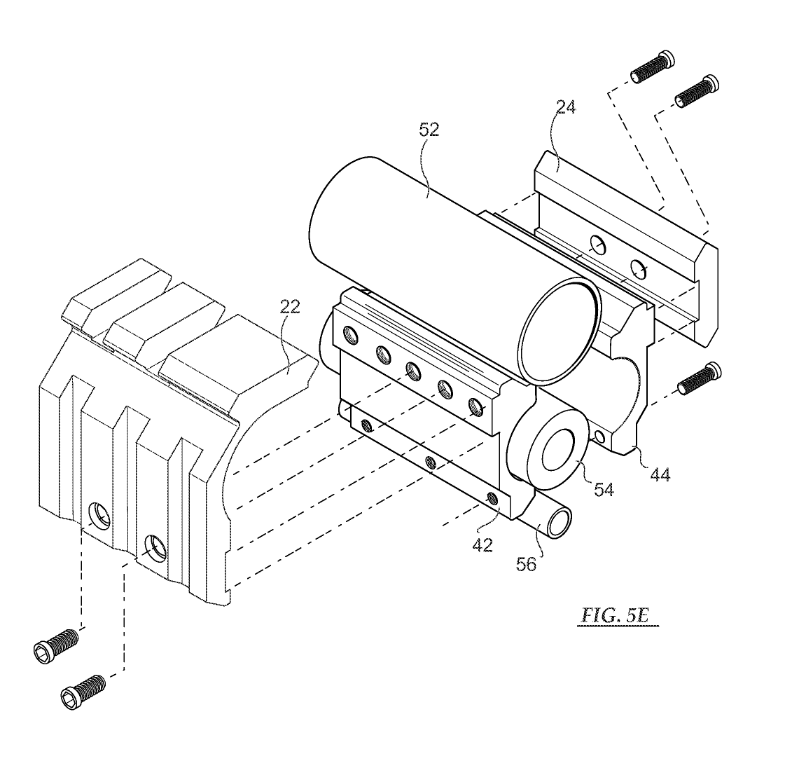

With regard to FIG. 5A, a cross-section view of the installed rail mount system is illustrated. The rail mount system does not fully enclose the gas piston tube to allow for proper airflow and ventilation. FIG. 5B depicts a side view of the installed rail mount system focused on the upper rail portion 22. The upper rail portion 22 is fixed into position on the base bracket 40 by a plurality of screws which pass through corresponding screw holes 25 on both the upper rail portion 22 and the base bracket 40. The lower rail portion 24 is also fixed into position on the base bracket 40 by a plurality of screws which pass through corresponding screw holes 25 on both the upper rail portion 22 and the base bracket 40.

Regarding FIGS. 5C through 5E illustrate the installation process of the rail mount modification system 10. The base bracket 40 must first be placed into position over the barrel 54 of the rifle 50 underneath the gas piston tube 52. Then, screws must be passed through both base bracket portions 42 and 44 to provide base support. The upper rail portion 22 and lower rail portion 24 must then be attached with additional screws to provide support the completed rail mount modification system 10.

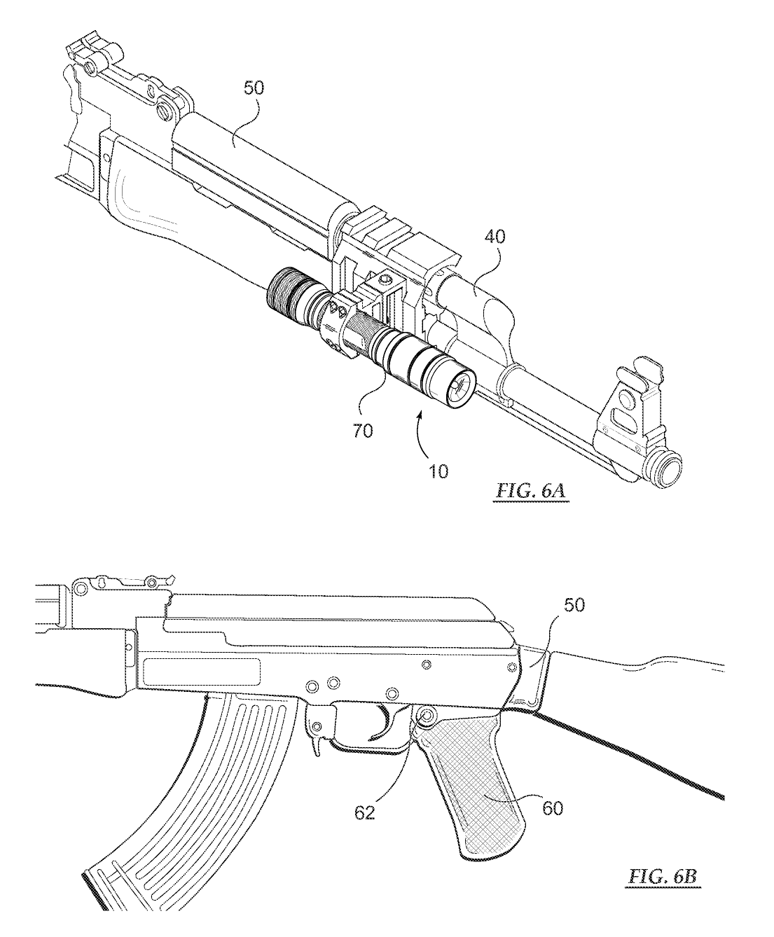

Another aspect of the rail mount modification system 10 is illustrated in FIGS. 6A and 6B. A flashlight 60 may be mounted onto the rail mount modification system 10. Additionally, the flashlight 60 may be remotely controlled by an embedded remote control 62 in a modified pistol grip 60. The modified pistol grip 60 would replace the existing grip on the rifle 50.

The embedded remote control 62 within the modified pistol grip 60 has a low-power radio frequency (RF) transmitter capable of being powered by a lithium-ion battery for up to 20 years. The embedded remote control 62 would be fully contained by the modified pistol grip 60 in such a way that a user will not need to service the parts on the remote control 62. Additionally, the embedded remote control 62 would be shielded from outside elements. The modified pistol grip 60 is sealed to be waterproof to protect the embedded remote control 62 and its components.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular rail mount and handgrip modification for a rifle as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A rail mount modification system, comprising:
a rail mount comprising an upper rail portion and a lower rail portion, wherein the rail mount is configured to receive a firearm attachment; and
a base bracket comprising a first bracket portion and a second bracket portion, wherein the rail mount is attached to the base bracket.

2. The rail mount modification system of claim 1, wherein the upper rail portion of the rail mount comprises a top rail and an upper lateral rail attachable to the base bracket.

3. The rail mount modification system of claim 1, wherein the lower rail portion of the rail mount comprises a lower lateral rail attachable to the base bracket.

4. The rail mount modification system of claim 1, wherein the base bracket is configured to be attached around a gas piston under a barrel of a rifle.

5. The rail mount modification system of claim 1, wherein the first bracket portion and the second bracket portion each have an inner cavity is shaped as a half cylinder configured to receive a gas piston.

6. The rail mount modification system of claim 1, wherein the upper rail portion is attached to the first bracket portion, and the lower rail portion is attached to the second bracket portion.

7. A handgrip modification system, comprising:
a modified pistol grip, wherein the modified pistol grip comprises a pistol grip, an embedded remote control and a power supply.

8. The handgrip modification system of claim 7, wherein the power supply is a lithium-ion battery and provides power to the embedded remote control.

9. The handgrip modification system of claim 7, wherein the embedded remote control is configured to remotely control an electronic device.

10. The handgrip modification system of claim 7, wherein the modified pistol grip is sealed to protect the embedded remote control and the power supply from external elements.

11. A method for providing a rail mount and handgrip modification, comprising:
providing a rail mount comprising an upper portion and a lower portion, wherein the rail mount is configured to receive a firearm attachment;
providing a base bracket comprising a first bracket portion and a second bracket portion, wherein the rail mount is attached to the base bracket; and
providing a modified pistol handgrip, wherein the modified pistol handgrip comprises an embedded remote control configured to remotely operate the firearm attachment and a power supply.

12. The method for providing a rail mount modification of claim 11 wherein the base bracket is configured to be attached around a gas piston and a barrel of a rifle.

13. The method for providing a rail mount modification of claim 11, wherein the upper portion of the rail mount comprises a top rail and a lateral rail attachable to the base bracket.

14. The method for providing a rail mount modification of claim 11, wherein the lower portion of the rail mount comprises a lateral rail attachable to the base bracket.

15. The method for providing a rail mount modification of claim 11, further comprising replacing a stock pistol handgrip with the modified pistol handgrip.

16. The method for providing a rail mount modification of claim 11, wherein the modified pistol grip is sealed to protect the embedded remote control and the power supply from external elements.
